(19) United States
(12) Patent Application Publication
(10) Pub. No.: US 2004/0175453 A1
(43) Pub. Date: Sep. 9, 2004

(54) Dough cutting die head

(76) Inventors: James R. Baeten, Bloomington, MN (US); Albert Boisvert, Ontario (CA); David M. Nathan, Minneapolis, MN (US)

Correspondence Address: GENERAL MILLS, INC., P.O. BOX 1113, MINNEAPOLIS, MN, 55440, US

(21) Appl. No.: 10/379,468

(22) Filed: Mar. 4, 2003

(51) Int. Cl. A21C 11/12; A21C 11/10

(52) U.S. Cl. 425/289

(57) ABSTRACT

A die head for cutting dough is disclosed. The die head includes a chamber defining a passageway for the flow of dough; a plurality of blades configured and arranged to extend across the chamber; each blade having a leading edge facing into the passageway of flow of dough and a trailing edge opposite the leading edge; and a plurality of serrations along at least one leading edge of one of the plurality of blades; the plurality of serrations configured and arranged to promote exposure of inclusions in the dough.

### FIELD OF THE INVENTION

The present invention is directed to an apparatus and method for preparing cookie dough. More specifically, the invention is directed to an apparatus and method for cutting extruded dough into wedges.

### BACKGROUND

Many restaurants, bakeries, grocery stores and other businesses sell fresh baked cookies. These cookies can be baked using dough that is mixed and baked at the same location, but many businesses prefer to bake the cookies on-site while having the dough purchased from a supply company as frozen cookie portions. Purchasing the frozen dough saves time and money, and can provide a more uniform, consistent, high quality products to customers. Although using frozen cookie dough portions provides many benefits, one notable disadvantage is that cookies made from such portions often lack a home cooked look because they do not contain high numbers of exposed inclusions, such as chocolate chunks. The lack of exposed inclusions is a result of the inherent properties of a laminar flow, such as dough. Typically inclusions in a laminar flow migrate to the interior of the flow, resulting in few exposed inclusions on the exterior of the cookie dough portions. Exposed inclusions are appealing to consumers because they indicate that the cookie has a high number of desirable chocolate pieces, nuts, etc., and also because they more accurately replicate home baked cookies.

These frozen cookie portions are usually formed by cookie depositors or formers, which are used to form small pieces of cookie dough that are subsequently frozen and then baked into individual cookies. Most existing cookie depositors either deposit a large puck that must be cut into wedges after freezing, or deposit wedges that do not have inclusions visible on the exterior of the cookie as a result of the inclusions migrating to the interior of the dough flow, creating a lower quality cookie. The large pucks that are cut into wedges after freezing can have good numbers of inclusions, but require an extra processing step that would be preferably eliminated. Deposited wedges that do not have visible inclusions are typically not desirable.

Therefore, a need exists for an improved apparatus and method for making cookie dough portions having large numbers of exposed inclusions.

### SUMMARY OF THE INVENTION

The present invention is directed to apparatuses and methods for forming dough, in particular cookie dough, into small portions for subsequent baking, such as at a restaurant, bakery, or home. The small portions, typically wedges, pucks or paddies, correspond to individual serving sizes that can be readily baked to form an attractive, properly sized baked item.

The portions are formed by using an extruder to force cooking dough through a die made in accordance with the invention. The die includes a passageway for the flow of dough through a die head, along with a plurality of blades in the die head configured and arranged to extend across the passageway. Each blade has a leading edge facing into the passageway of flow of dough and a trailing edge opposite the leading edge. The leading edge of the blades is a cutting edge and the trailing edge opposite the leading edge is a blunt surface. The leading edge of the blades can contain a plurality of serrations or alternatively scallops configured and arranged to break inclusions in the cookie dough as the dough passes across the blade. In some implementations multiple blades are used to cut the dough.

The number of serrations or scallops should be sufficient to effectively grab onto and cut inclusions within the cookie dough. The number of serrations can vary depending upon, for example, the size of the inclusions in the cookie dough and the density or number of inclusions. Generally there are at least two serrations per inch of a blade, usually less than twenty serrations per inch. Typically all serrations are the same size, but alternatively the size of serrations can be varied. For example, the blades can contain alternating large and small serrations, or numerous small serrations can be combined with less frequent large serrations. In addition, compound serrations can be produced which have large serrations onto which smaller serrations have been formed.

The above summary of the present invention is not intended to describe each disclosed embodiment or every implementation of the present invention. The figures and the detailed description which follow more particularly exemplify these embodiments.

### FIGURES

The invention can be further understood by reference to the following figures:

FIG. 1 is a perspective view of a dough puck made using the apparatus and method of the invention.

FIG. 2A is a side cross sectional view of a die head constructed and arranged in accordance with the invention, the cross section taken parallel to the direction of dough flow.

FIG. 2B is a side cross sectional view of a die head constructed and arranged in accordance with the invention, the cross section taken parallel to the direction of dough flow.

FIG. 2C is a side cross sectional view of a die head constructed and arranged in accordance with the invention, the cross section taken parallel to the direction of dough flow.

FIG. 2D is a side cross sectional view of a die head constructed and arranged in accordance with the invention, the cross section taken parallel to the direction of dough flow.

FIG. 3 is a cross sectional view of a die head constructed and arranged in accordance with the invention, the cross section taken perpendicular to the direction of dough flow.

FIG. 4A is a cross sectional view of a die head constructed and arranged in accordance with the invention, the cross section taken perpendicular to the direction of dough flow.

FIG. 4B is a cross sectional view of a die head constructed and arranged in accordance with the invention, the cross section taken perpendicular to the direction of dough flow.

FIG. 5 is a perspective view of a dough puck made using the apparatus and method of the invention.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover various modifications, equivalents, and alternatives falling within the spirit and scope of the invention.

### DETAILED DESCRIPTION

The present invention is directed to apparatuses and methods for forming baking dough, in particular cookie dough, into small portions for subsequent cooking. The small portions, typically wedges, pucks or paddies, correspond to individual serving sizes that can be readily baked to form an attractive, properly sized cooked item. The dough is typically processed using the apparatus and methods of the invention in a food processing plant, where the dough is formed into smaller portions that are frozen and then shipped to other places for baking, such as restaurants and bakeries.

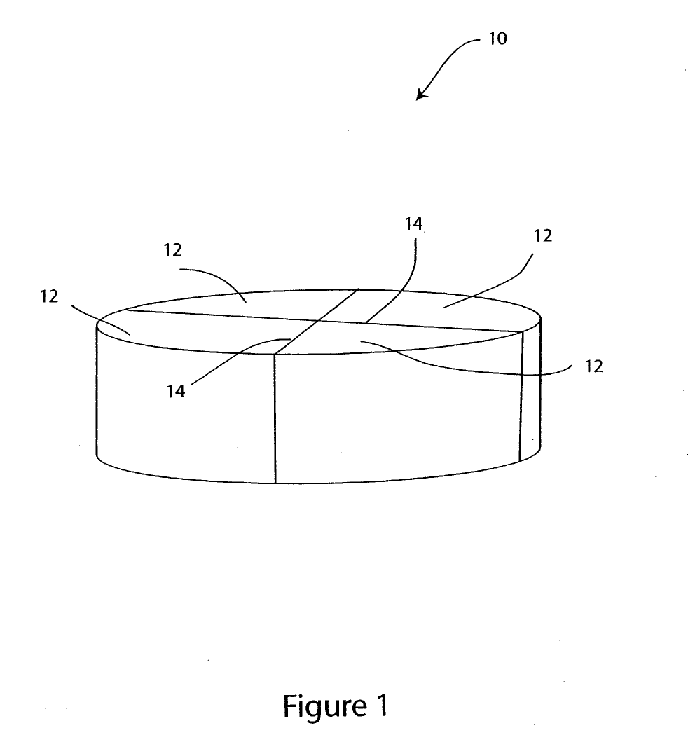

A perspective view of a dough puck 10 made in accordance with the invention is shown in FIG. 1. The dough puck 10 is shown divided into four wedges 12 that have been cut along lines 14 to form the separate wedges 12 of the puck 10. The wedges 12 may be lightly held together along the wedge edges or can be completely separate from one another. Each wedge 12 is subsequently baked to form a cookie, thus dough puck 10 has four wedges 12 and will produce four cookies when divided and baked. The wedges 12 are generally frozen after being formed, allowing the wedges 12 to be easily shipped and stored prior to baking.

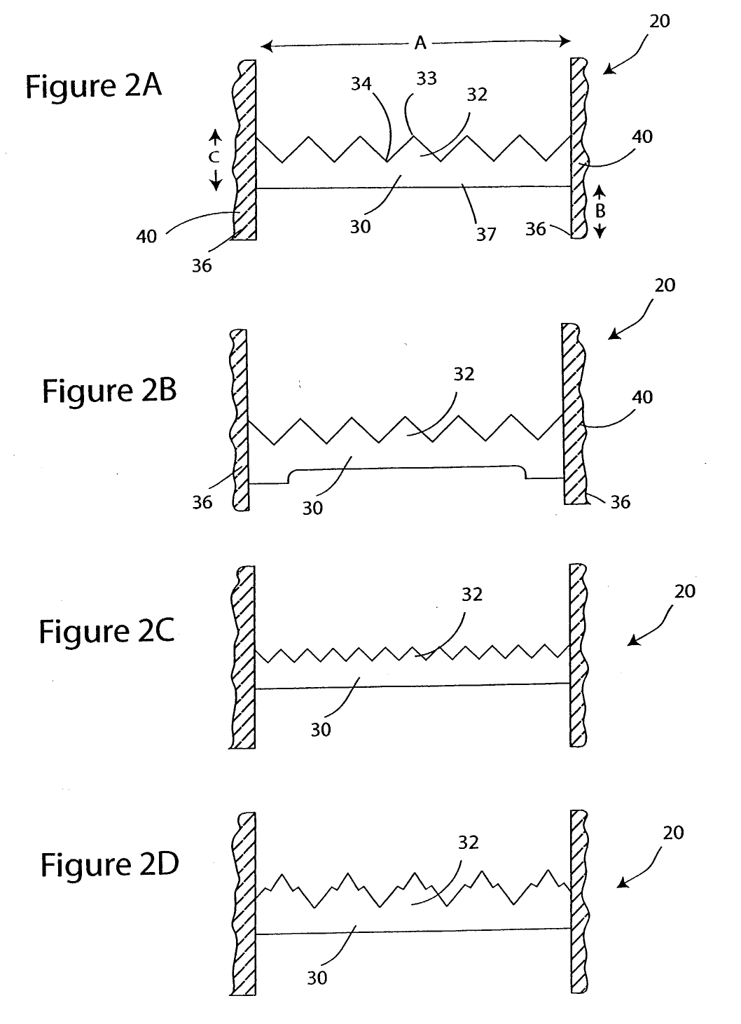

In reference now to FIGS. 2A to 2D, blades used for forming the wedges are shown. In particular, blades having cutting edges that make the cuts 14 in the puck 10 of FIG. 1 are shown. These figures are taken along a cross section of an extrusion die head 20, showing the walls 40 of the die head along with a blade 30 extending across the die head 20 between the walls 40. The blade 30 can be straight-edged, fluted, scalloped, or serrated. The blade 30 can be maintained at an ambient temperature throughout the process. As is shown in FIG. 2A, the blade 30 can have a multitude of serrations 32 having peaks 33 and valleys 34. These serrations function to promote the cracking or cutting of inclusions in the dough, while leaving the inclusions well exposed on the surface of each wedge. Types of inclusions useful in the dough include chocolate, nuts, hard candies, raisins, fruit bits, etc. The exposed inclusions assist in making an appealing baked product with the inclusions exposed on the top of the cookie after baking.

The number and size of the serrations 32 can vary depending upon the application. In most implementations at least four serrations are provided in each blade 30, and normally two blades are provided in each die head, the blades positioned at approximately a 90° angle to one another. Although most implementations of the invention have at least two serrations in each blade, in general more than four serrations are provided. Typically at least six serrations are present, and often more than ten. In some embodiments fifteen, twenty, or more serrations can be present.

Dimension A in FIG. 2A corresponds to the internal width of the die head 20. The width is highly variable depending upon the dough being extruded and other factors. In most implementations the width is between two and five inches, often from two and a half to four and a half inches. Common widths include two, three, and four inch widths. Also, the blades 30 are generally positioned near the exit end 36 of the die head 20. The distance B between the bottom blunt edge 37 of the blade 30 and the exit end 36 of the die head 20 is typically relatively short, normally less than a half inch, and more commonly less than a quarter inch. The longer the distance B, the greater the likelihood the individual wedges will reconnect to one another. Therefore, distance B is generally long enough to keep the wedges lightly connected, but not so long that they completely fuse together. The height of the serrations, which corresponds to Dimension C of FIG. 2A, is the distance from the bottom edge 37 of the blade 30 to the top 33 of the serrations. Dimension C is typically at least 1/16 inch, but can be less. In some implementations it is from 1/16 to 1/8 inches, while in yet other implementations it is from ¼ to 1½ inches.

Further aspects of the invention are shown in FIG. 2B, which has a blade 30 in which the bottom edge 37 is narrower near its middle than near the walls of the die head. Such designs can be desirable because they provide a narrow blade but also provide a stable connection to the walls of the die head. FIG. 2C shows a blade 30 with a higher number of teeth than FIGS. 2A and 2B, while FIG. 2D shows compound serrations having serrations on top of serrations.

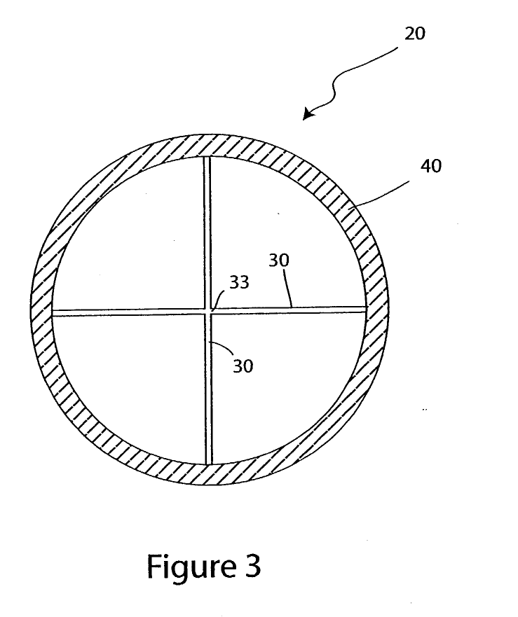

In reference now to FIG. 3, an end cross sectional view of a die head 20 made in accordance with the invention is shown. A die head 20 includes two blades 30 crossing the die head 20 and joined to walls 40. Although blades 30 are described as being two separate blades, it will be appreciated that they can be one blade connected at a central point 33, or alternatively can be four blades that are not connected at the central point 33. Furthermore, the blades can be two blades that overlap at the central point 33. Other blade configurations are also possible.

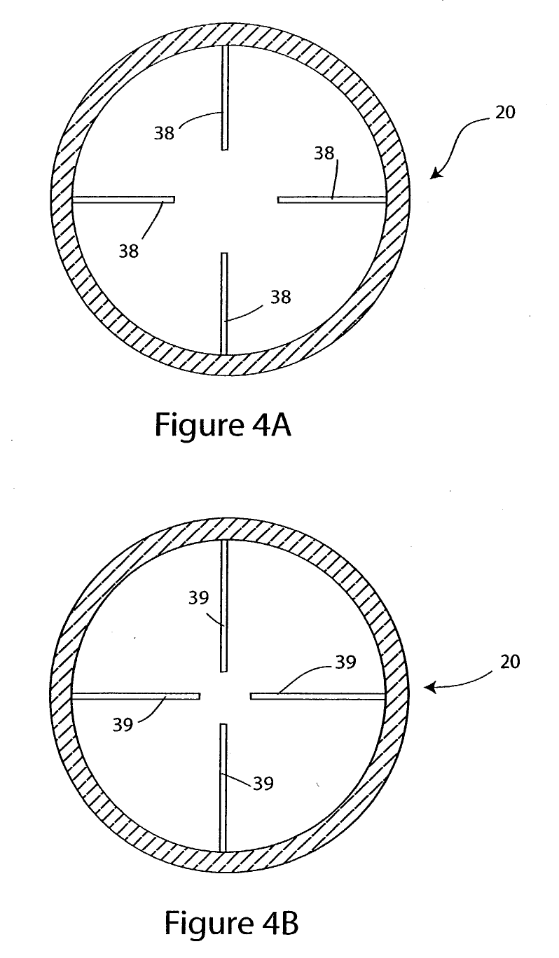

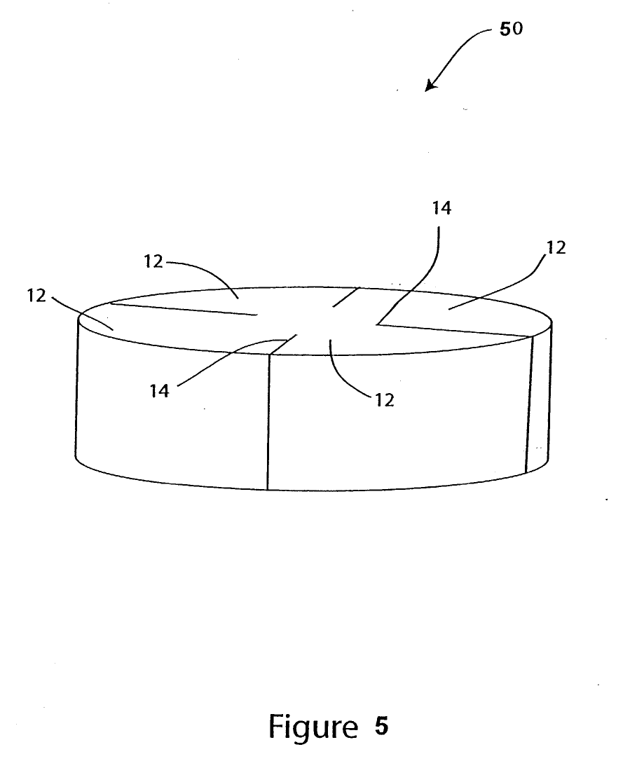

FIGS. 4A and 4B show two additional blade configurations. In FIG. 4A blades 38 in the die head 20 do not reach all the way to the center of the die, leaving a large area in the center of the die that is not crossed by a blade. Similarly, FIG. 4B has blades 39 that do not reach all the way to the center of the die head, although they reach closer to the center than the blades of the embodiment in FIG. 4A. The knife arrangements of FIGS. 4A and 4B result in the formation of a puck that has wedges that are not entirely separate from one another, as shown in puck 50 of FIG. 5. Such pucks have the advantage of keeping the wedges together, which can subsequently be broken apart prior to use.

The die head of the present invention can be used in commercially available formers such as the F-6, F-26, or F-400 available from Formax® USA having an address of 9150 191^{st} Street, Mokena, Ill. 60448.

Another commercially available former useful for the present invention is a former with a Model No. VM400HD available from Convenient Food Systems having an address of 8000 N. Dallas Parkway, Frisco, Tex. 75034.

In some implementations multiple blades are used, and the leading edge of each blade contains serrations. The number of serrations should be sufficient to effectively cut inclusions within the cookie dough. This number can vary depending upon, for example, the size of the inclusions in the cookie dough and the density or number of inclusions. Generally there are at least four serrations per inch of the blades, and usually less than ten serrations per inch. Typically all serrations are the same size, but certainly the size of serrations can be greatly varied. For example, alternating large and small serrations can be used, or numerous small serrations can be combined with occasional large serrations. In addition, compound serrations can be produced which have large serrations onto which smaller serrations have been formed.

The present invention should not be considered limited to the particular examples described above, but rather should be understood to cover all aspects of the invention as fairly set out in the attached claims. Various modifications, equivalent processes, as well as numerous structures to which the present invention may be applicable will be readily apparent to those of skill in the art to which the present invention is directed upon review of the instant specification.

We claim:

1. A die head for forming and cutting dough, the die comprising:
a chamber defining a passageway for the flow of dough;
a plurality of blades configured and arranged to extend across the chamber; each blade having a leading edge facing into the passageway of flow of dough and a trailing edge opposite the leading edge; and
a plurality of serrations along at least one leading edge of one of the plurality of blades; the plurality of serrations configured and arranged to break inclusions in the dough.

2. The die head of claim 1, wherein all leading edges of the plurality of the blades contain serrations.

3. The die head of claim 1, wherein the plurality of blades are maintained at an ambient temperature.

4. The die head of claim 1, wherein the serrations are 1/16 to 1½ inches in height.

5. The die head of claim 1, wherein the leading edge of the blades have at least two serrations per inch.

6. The die head of claim 1, wherein the leading edge of the blades have less than twenty serrations per inch.

7. The die head of claim 1, wherein the blades do not completely divide the chamber.

8. An apparatus for processing dough, the apparatus comprising:
a source of pressurized dough;
a chamber for receiving the pressurized dough, the chamber defining a passageway for the flow of dough;
a plurality of blades configured and arranged to extend across the chamber; each blade having a leading edge facing into the passageway of flow of dough and a trailing edge opposite the leading edge; and
a plurality of serrations along at least one leading edge of one of the plurality of blades; the plurality of serrations configured and arranged to break inclusions in the dough.

9. The apparatus of claim 8, wherein all leading edges of the plurality of the blades contain serrations.

10. The apparatus of claim 8, wherein the plurality of blades are maintained at an ambient temperature.

11. The apparatus of claim 8, wherein the serrations are 1/16 to 1½ inches in height.

12. The apparatus of claim 8, wherein the leading edge of the blades has at least two serrations per inch.

13. The apparatus of claim 8, wherein the leading edge of the blades have less than twenty serrations per inch.

14. The apparatus of claim 8, wherein the blades do not completely divide the chamber.

15. A method of processing dough, the method comprising forcing dough across an extrusion die having serrated blades.

16. The method of claim 15, wherein the serrated blades are maintained at an ambient temperature.

17. The method of claim 15, wherein the blades have at least two serrations per inch.

18. The method of claim 15, wherein the blades have less than twenty serrations per inch.
